(19) United States
(12) Patent Application Publication
(10) Pub. No.: US 2019/0227302 A1
(43) Pub. Date: Jul. 25, 2019

(54) SCANNING-TYPE DEVICE AND SCANNER UNIT

(71) Applicant: OLYMPUS CORPORATION, Tokyo (JP)

(72) Inventors: Masashi YAMADA, Tokyo (JP); Hiroshi TSURUTA, Kanagawa (JP)

(73) Assignee: OLYMPUS CORPORATION, Tokyo (JP)

(21) Appl. No.: 16/372,583

(22) Filed: Apr. 2, 2019

Related U.S. Application Data
(63) Continuation of application No. PCT/JP2016/081048, filed on Oct. 20, 2016.

(51) Int. Cl. G02B 26/10; F21V 8/00

(52) U.S. Cl. CPC G02B 26/103; G02B 2006/0098; G02B 6/0008

(57) ABSTRACT

A scanning-type device includes: an optical fiber; a vibration unit vibrating a distal end of the optical fiber in a direction perpendicular to a longitudinal axis of the optical fiber; an outer tube accommodating the optical fiber and the vibration unit; and a support member supporting the vibration unit in the outer tube, the vibration unit having: a piezoelectric element expanding and contracting in the longitudinal-axis direction of the optical fiber; and a cylindrical vibration transmitting member disposed between the piezoelectric element and the optical fiber and transmitting expansion and contraction vibrations of the piezoelectric element to the optical fiber; the support member has a V-groove extending along a longitudinal axis of the outer tube to support the vibration transmitting member; and an outer surface of a section of the vibration transmitting member supported by the V-groove is a cylindrical surface extending along the longitudinal axis of the optical fiber.

### CROSS-REFERENCE TO RELATED APPLICATIONS

This is a continuation of International Application PCT/JP2016/081048, with an international filing date of Oct. 20, 2016, which is hereby incorporated by reference herein in its entirety.

### TECHNICAL FIELD

The present invention relates to a scanning-type device and a scanner unit.

### BACKGROUND ART

In the related art, there is a known optical fiber scanner that is assembled by inserting a unit composed of an optical fiber that emits guided light from a distal end thereof and a vibration unit that vibrates the distal end of the optical fiber in a direction intersecting the longitudinal axis, into a cylindrical holding part in which an illumination lens is mounted at one end thereof, from the other end of the holding part, and by fixing the unit to the holding part by means of a cylindrical support member (for example, see PTL

### CITATION LIST

### Patent Literature

{PTL 1} Japanese Unexamined Patent Application, Publication No. 2015-146910

### SUMMARY OF INVENTION

One aspect of the present invention provides a scanning-type device including: an optical fiber that guides illumination light and that emits the illumination light from a distal end thereof; a vibration unit that vibrates the distal end of the optical fiber in a direction perpendicular to a longitudinal axis of the optical fiber; an optical system that focuses the illumination light emitted from the distal end of the optical fiber; an outer tube that accommodates the optical fiber, the vibration unit, and the optical system; and a support member to support the vibration unit in the outer tube, wherein the outer tube and the support member have a structure in which at least the optical fiber can be accommodated therein from a direction perpendicular to the longitudinal axis of the outer tube.

Furthermore, another aspect of the present invention provides a scanner unit including: an optical fiber; a piezoelectric element in which an active portion formed by being sandwiched between electrodes and an inactive portion having no electrodes are coupled and that expands and contracts in a longitudinal-axis direction of the optical fiber through application of a voltage; and a vibration transmitting member that transmits expansion and contraction vibrations of the piezoelectric element to the optical fiber, wherein the optical fiber is accommodated in a center of the vibration transmitting member or in a center of a tube having a square transverse cross-section and obtained by combining the vibration transmitting member and the piezoelectric element; and the vibration transmitting member is configured to be split, or the vibration transmitting member and the piezoelectric element are configured to be split.

Another aspect of the present invention provides a scanner unit including: an optical fiber; and two or more piezoelectric elements in each of which an active portion formed by being sandwiched between electrodes and an inactive portion having no electrodes are coupled and that expand and contract in a longitudinal-axis direction of the optical fiber through application of a voltage, wherein the optical fiber is accommodated in a center of a tube having a square transverse cross-section and obtained by combining the two or more piezoelectric elements; and the two or more piezoelectric elements are configured to be split.

### BRIEF DESCRIPTION OF DRAWINGS

FIG. 1 is a longitudinal sectional view showing an optical-scanning-type observation system that is provided with an optical-scanning-type observation device according to the present invention.

FIG. 2 is a longitudinal sectional view showing the optical-scanning-type observation device according to a first embodiment of the present invention.

FIG. 3 is a longitudinal sectional view showing a distal end of an optical-scanning-type illumination device provided in the optical-scanning-type observation device shown in FIG. 1.

FIG. 4 is an exploded perspective view of the optical-scanning-type illumination device shown in FIG. 3.

FIG. 5 is a transverse sectional view showing the optical-scanning-type illumination device shown in FIG. 3.

FIG. 6 is a perspective view showing a first modification of the optical-scanning-type illumination device shown in FIG. 3.

FIG. 7 is a perspective view showing a second modification of the optical-scanning-type illumination device shown in FIG. 3.

FIG. 8 is a perspective view showing a third modification of the optical-scanning-type illumination device shown in FIG. 3.

FIG. 9 is a perspective view showing a fourth modification of the optical-scanning-type illumination device shown in FIG. 3.

FIG. 10 is a perspective view showing a fifth modification of the optical-scanning-type illumination device shown in FIG. 3.

FIG. 11 is a perspective view showing a sixth modification of the optical-scanning-type illumination device shown in FIG. 3.

FIG. 12 is a perspective view showing a seventh modification of the optical-scanning-type illumination device shown in FIG. 3.

FIG. 13 is a perspective view showing an optical-scanning-type illumination device according to a second embodiment of the present invention.

FIG. 14 is a transverse sectional view showing the optical-scanning-type illumination device shown in FIG. 13.

FIG. 15 is a perspective view showing a first modification of the optical-scanning-type illumination device shown in FIG. 13.

FIG. 16 is a perspective view showing a second modification of the optical-scanning-type illumination device shown in FIG. 13.

### DESCRIPTION OF EMBODIMENTS

An optical-scanning-type illumination device 2 and an optical-scanning-type observation device 1 according to a first embodiment of the present invention and an optical-scanning-type observation system 100 that is provided with the optical-scanning-type observation device 1 will be described below with reference to the drawings.

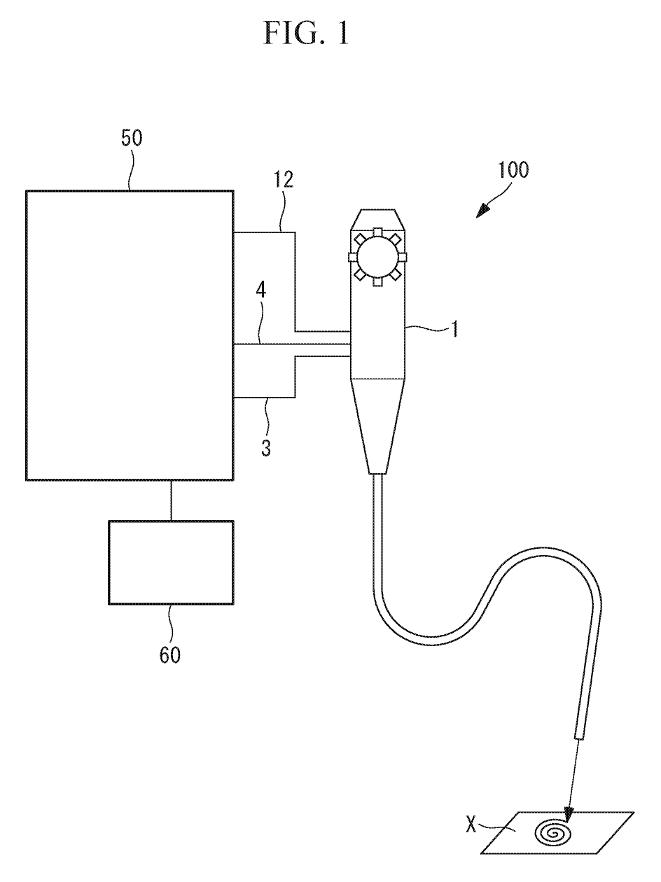

As shown in FIG. 1, the optical-scanning-type observation system 100 is provided with: the optical-scanning-type observation device 1 of this embodiment; a drive control device 50 that controls the optical-scanning-type observation device 1; and a monitor 60.

The optical-scanning-type observation system 100 is an observation system that scans illumination light on an object X along a spiral scanning trajectory and that acquires an image of the object X.

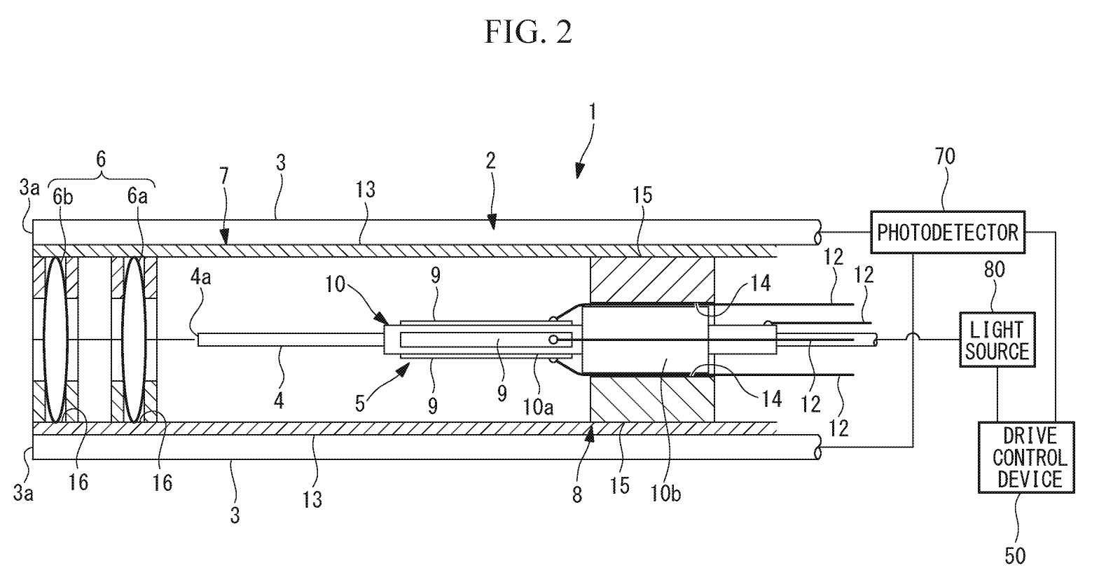

As shown in FIG. 2, the optical-scanning-type observation device 1 of this embodiment is provided with: the optical-scanning-type illumination device 2, which radiates illumination light onto the object X; a plurality of light-receiving optical fibers 3 that are circumferentially arranged on the outer circumference of the optical-scanning-type illumination device 2 and that are disposed such that light-receiving ends 3a thereof are made to face forward; and a photodetector 70 that detects return light returning from the object X and guided by the light-receiving optical fibers 3.

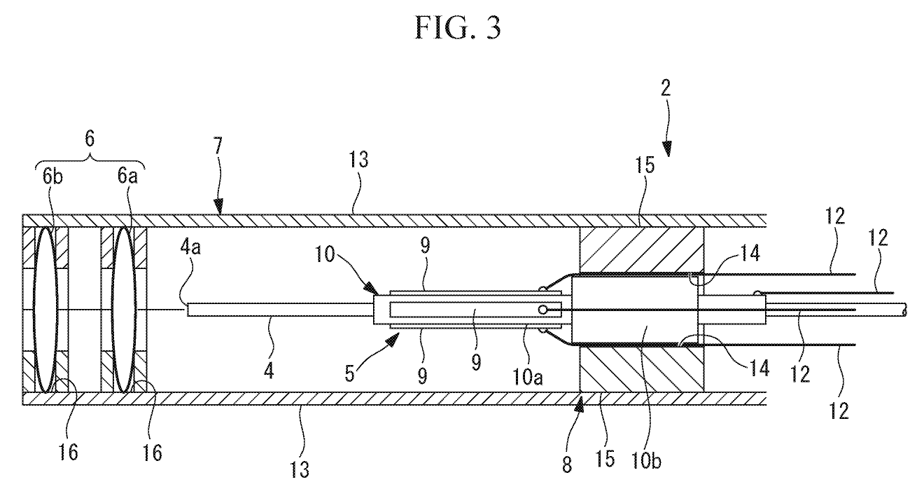

As shown in FIGS. 2 and 3, the optical-scanning-type illumination device 2 of this embodiment is provided with: a light source 80 that generates illumination light; an optical fiber 4 that guides the illumination light from the light source 80; a vibration unit 5 that vibrates a distal end 4a of the optical fiber 4; an optical system 6 that focuses the illumination light emitted from the distal end 4a of the optical fiber 4; a cylindrical outer tube 7 that accommodates the optical fiber 4, the vibration unit 5, and the optical system 6; and a support part 8 that supports the vibration unit 5 in the outer tube 7.

The vibration unit 5 is provided with: four piezoelectric elements 9; and a ferrule (vibration transmitting member) 10 that is disposed between the piezoelectric elements 9 and the optical fiber 4. The ferrule 10 is provided with a square cylinder section 10a to which the respective four piezoelectric elements 9 are bonded and a circular cylinder section 10b that is supported by the support member 8, and is also provided with a through-hole 11 that penetrates through the centers of the square cylinder section 10a and the circular cylinder section 10b in the longitudinal-axis direction and to which the optical fiber 4 is bonded in a penetrating state.

Each of the piezoelectric elements 9 is formed of a strip-shaped piezo element and contracts in the longitudinal direction when a voltage is supplied between electrodes 40 formed on two surfaces of the piezo element that are opposed in the thickness direction. In the example shown in FIG. 2, the four piezoelectric elements 9 (only three of the piezoelectric elements are shown in FIG. 2) are attached to respective surfaces of the square cylinder section 10a of the ferrule 10 by means of an electrically conductive adhesive agent.

One of the two piezoelectric elements 9 that are disposed at such positions as to sandwich the ferrule 10 is made to expand, and the other is made to contract, thereby making it possible to generate a driving force for bending the ferrule 10 and to vibrate the optical fiber 4, which penetrates through the through-hole 11 of the ferrule 10, in the radial direction. In the figure, reference sign 12 denotes wires for supplying voltages to the piezoelectric elements 9. The ferrule 10 is made of an electrically conductive metal material, or the ferrule 10 is made of a resin, and an electrically conductive film is formed and grounded on a surface of the resin ferrule 10, thereby using the ferrule 10 as a common ground for the four piezoelectric elements 9.

In this embodiment, the outer tube 7 is formed to have a cylindrical shape by combining two semi-circular tube members (split members) 13 that are split along a parting line in the longitudinal-axis direction. The semi-circular tube members 13 are each provided with, on an inner surface thereof, a semi-circular cylindrical split support member (split member) 15 that has a V-groove 14 for supporting the circular cylinder section 10b of the ferrule 10, and lens accommodating parts 16 that form accommodation grooves for accommodating the optical system 6, which is formed of disk-like lenses 6a and 6b. The two split support members 15 are combined, thus forming the support member 8.

The V-grooves 14, which are formed in the split support members 15, are provided so as to form a through-hole that has a square cross-section whose one side corresponds to the length of the diameter of the circular cylinder section 10b of the ferrule 10, along the longitudinal-axis direction of the outer tube 7 when the two split support members 15, which are provided in the two semi-circular tube members 13, are combined.

Two example assembly methods for the thus-configured optical-scanning-type illumination device 2 of this embodiment will be described below.

In order to assemble the optical-scanning-type illumination device 2 of this embodiment by using a first assembly method, first, the optical fiber 4 is made to penetrate through the through-hole 11 in the ferrule 10, and then, an end face of the optical fiber 4 is subjected to cleavage. After the length of a protruding section of the optical fiber 4 is adjusted to a desired length, the ferrule 10 and the optical fiber 4 are adhesively fixed to each other. The piezoelectric elements 9 are respectively bonded to the four surfaces of the square cylinder section 10a of the ferrule 10, and the wires 12 are respectively fixed to outer surfaces of the piezoelectric elements 9 and a surface of the ferrule 10, thereby forming the scanner unit (vibration unit) 5.

Next, in a state in which the two semi-circular tube members 13, which constitute the outer tube 7, are split along the parting line, the scanner unit 5 is made to approach the inside of one of the semi-circular tube members 13 from a radial direction (direction perpendicular to the longitudinal axis), and the circular cylinder section 10b of the ferrule 10 is disposed on the V-groove 14 in the split support member 15.

Furthermore, the lenses 6a and 6b are accommodated in the lens accommodating parts 16 from a radial direction.

Thereafter, the distance between the lens 6a and the distal end 4a of the optical fiber 4 is adjusted, and the ferrule 10 and the split support member 15 are bonded by an adhesive agent.

Finally, the other one of the semi-circular tube members 13 is covered so as to form the cylindrical outer tube 7, the two semi-circular tube members 13 are bonded by the adhesive agent, and the ferrule 10 and the split support member 15 that is provided in the other one of the semi-circular tube members 13 are bonded by the adhesive agent. Accordingly, the optical-scanning-type illumination device 2 of this embodiment is assembled.

The distance between the lens 6a and the distal end 4a of the optical fiber 4 is adjusted by moving the ferrule 10, in which the optical fiber 4 is fixed, in the longitudinal-axis direction with respect to the support member 8, while viewing the distance between the lens 6a and the distal end 4a of the optical fiber 4 through a microscope, and by adjusting the focus position of light from the optical fiber 4. The focus position is adjusted by causing illumination light to be emitted from the distal end 4a of the optical fiber 4 and by measuring a spot diameter at a predetermined distance. Furthermore, it is also possible to use an interferometer instead of the microscope, to cause laser light from the interferometer to enter the optical system 6 of the optical-scanning-type observation device 1, and to adjust the distance between the lens 6a of the optical system 6 and the distal end 4a of the optical fiber 4 while referring to the interference peak.

Furthermore, in order to assemble the optical-scanning-type illumination device 2 of this embodiment by using a second assembly method, first, the optical fiber 4 is made to penetrate through the through-hole 11 in the ferrule 10, and then, the end face of the optical fiber 4 is subjected to cleavage. The piezoelectric elements 9 are respectively bonded to the four surfaces of the square cylinder section 10a of the ferrule 10, and the wires 12 are respectively fixed to the outer surfaces of the piezoelectric elements 9 and the surface of the ferrule 10, thereby forming the scanner unit (vibration unit) 5.

Next, in a state in which the two semi-circular tube members 13, which constitute the outer tube 7, are split along the parting line, the scanner unit 5 is made to approach the inside of one of the semi-circular tube members 13 from a radial direction (direction perpendicular to the longitudinal axis), and the circular cylinder section 10b of the ferrule 10 is disposed on the V-groove 14 in the split support member 15.

Furthermore, the lenses 6a and 6b are accommodated in the lens accommodating parts 16 from a radial direction.

Thereafter, the distance between the lens 6a and the distal end 4a of the optical fiber 4 is adjusted, the ferrule 10 and the optical fiber 4 are bonded by the adhesive agent, and the ferrule 10 and the split support member 15 are bonded by the adhesive agent.

Finally, the other one of the semi-circular tube members 13 is covered so as to form the cylindrical outer tube 7, the two semi-circular tube members 13 are bonded by the adhesive agent, and the ferrule 10 and the split support member 15 that is provided in the other one of the semi-circular tube members 13 are bonded by the adhesive agent. Accordingly, the optical-scanning-type illumination device 2 of this embodiment is assembled.

The distance between the lens 6a and the distal end 4a of the optical fiber 4 is adjusted by moving the optical fiber 4 inside the through-hole 11 in the ferrule 10 or by moving the ferrule 10, in which the optical fiber 4 is fixed, in the longitudinal-axis direction with respect to the support member 8, while viewing the distance between the lens 6a and the distal end 4a of the optical fiber 4 through a microscope, and by adjusting the focus position of light from the optical fiber 4. The focus position is adjusted by causing illumination light to be emitted from the distal end 4a of the optical fiber 4 and by measuring a spot diameter at a predetermined distance.

The above-described two assembly methods have an advantage in that the distance between the lens 6a and the distal end 4a of the optical fiber 4 is confirmed by means of a microscope before the two semi-circular tube members 13 are assembled, thereby making it possible to perform the confirmation work in a wider space.

Instead of this, the adjustment work for the focus position may be performed by moving the optical fiber 4 back and forth with respect to the ferrule 10 after the two semi-circular tube members 13 are combined and bonded.

In this way, according to the optical-scanning-type illumination device 2 of this embodiment, because the outer tube 7 is composed of the two semi-circular tube members 13, which are split along the parting line, the scanner unit 5, which is provided with the optical fiber 4, need not be inserted starting from the distal end 4a of the optical fiber 4 toward a base-end opening of the cylindrical outer tube 7. Specifically, when the optical fiber 4 is accommodated in the outer tube 7, because movement work of the optical fiber 4 in the longitudinal-axis direction is not involved, there is an advantage in that damage of the distal end 4a of the optical fiber 4 can be prevented at the time of assembly.

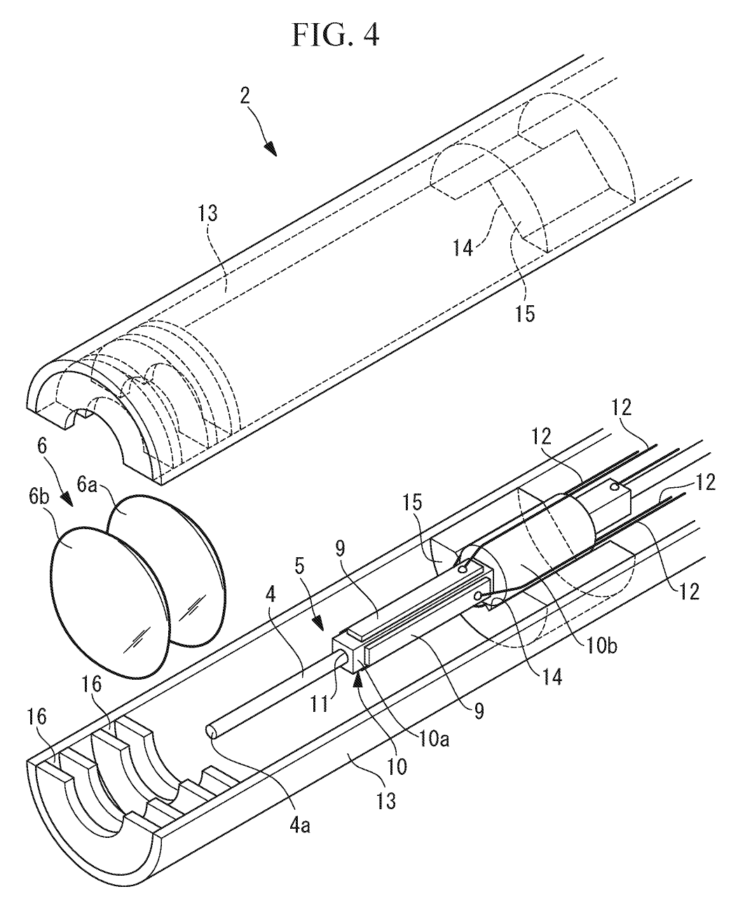

Furthermore, according to this embodiment, the sizes of the V-grooves 14 in the support member 8 are set so as to form, when the two split support members 15 are combined, a columnar hole having a square transverse cross-section whose one side corresponds to the size of the outer diameter of the circular cylinder section 10b of the ferrule 10. Accordingly, as shown in FIG. 4, the circular cylinder section 10b of the ferrule 10 is tightly accommodated between the V-grooves 14 of the two split support members 15, thus making it possible to more reliably support the circular cylinder section 10b of the ferrule 10 so as not to cause the circular cylinder section 10b to vibrate.

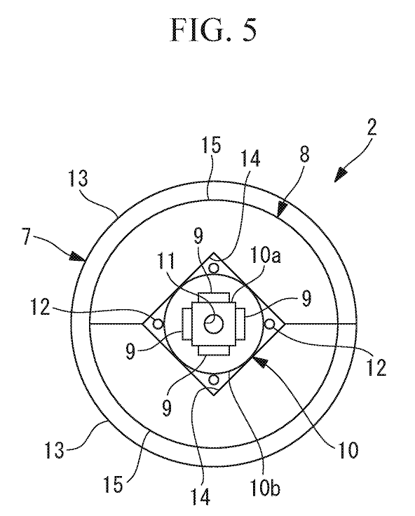

Then, as shown in FIG. 5, because gaps are formed at four corners between the circular cylinder section 10b of the ferrule 10 and the V-grooves 14 of the split support members 15, there is an advantage in that the wires 12 can be easily routed to the four piezoelectric elements 9 through the gaps.

Note that, in this embodiment, although the V-grooves 14 of the split support members 15 and the circular cylinder section 10b of the ferrule 10 are combined in order to improve the ease of assembly, instead of this, the square cylinder section 10a of the ferrule 10 may be combined with the support member 8, or semi-circular tubular inner surfaces may be provided in the split support members 15 and may be combined with the circular cylinder section 10b of the ferrule 10.

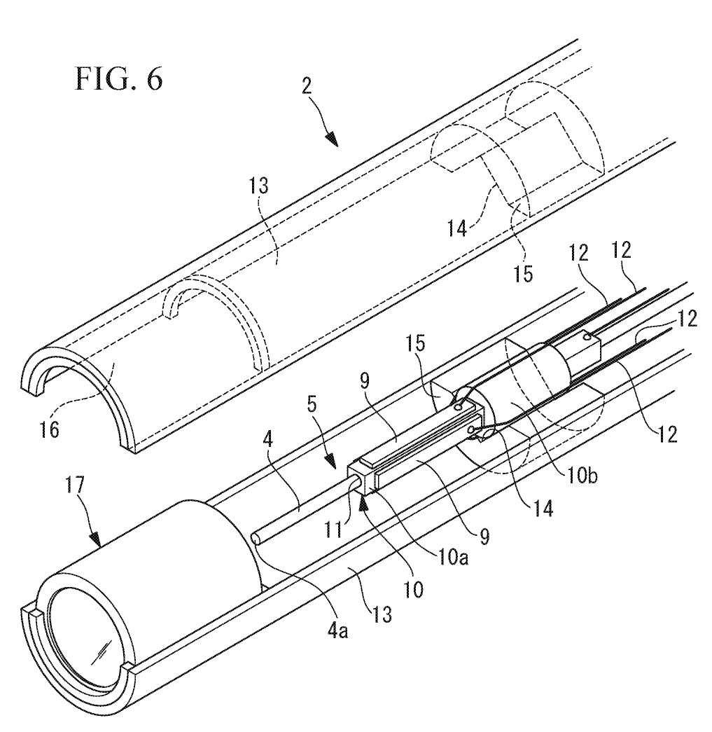

Furthermore, in this embodiment, although the individual lenses 6a and 6b are accommodated in the lens accommodating parts 16, which are provided on the inner surfaces of the semi-circular tube members 13, instead of this, as shown in FIG. 6, it is also possible to accommodate a lens unit (optical system) 17 in a lens accommodating part 16.

Furthermore, in this embodiment, although the outer tube 7 is split into two members, the outer tube 7 may be split into three or more members.

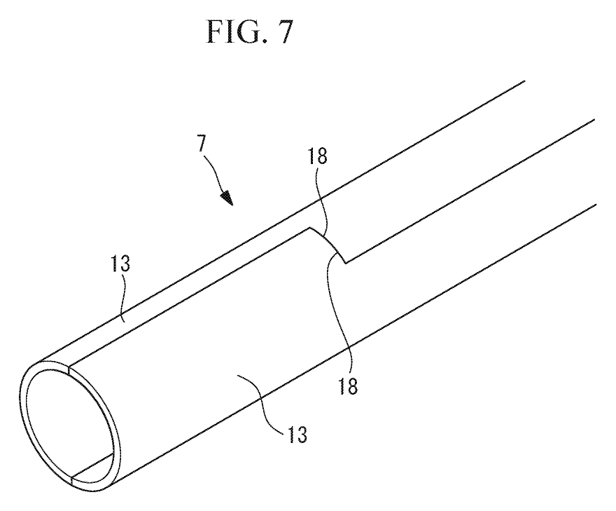

Furthermore, in this embodiment, as shown in FIG. 7, the semi-circular tube members 13 may be provided with engagement sections 18 that are engaged with each other in the axial direction. The engagement sections 18 can be step sections or a recessed section and a protruding section on split surfaces.

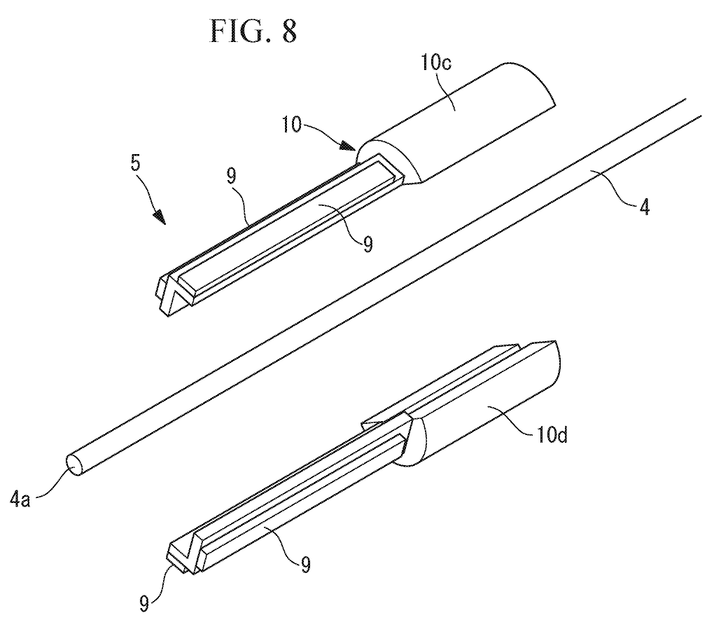

Furthermore, in this embodiment, although an integrated cylindrical member that has the through-hole 11, through which the optical fiber 4 is made to penetrate, is shown as an example of the ferrule 10, instead of this, as shown in FIG. 8, the ferrule 10 may also be formed to have a one-split structure composed of a plurality of (two) split vibration-transmitting members 10c and 10d that are split along a parting line in the longitudinal-axis direction.

By doing so, the split vibration-transmitting members 10c and 10d, which are split in half, are respectively bonded to the split support members 15 in the respective semi-circular tube members 13, the optical fiber 4, which is a single item, is moved in a radial direction and is accommodated in the split vibration-transmitting member 10c, the split vibration-transmitting member 10d, which is bonded to the split support member 15 in the corresponding semi-circular tube member 13, is covered so as to sandwich the optical fiber 4, and the split vibration-transmitting members 10c and 10d are fixed to each other by the adhesive agent, thereby making it possible to perform assembly.

In a method for splitting the ferrule 10 and the piezoelectric elements 9, as shown in FIG. 8, it is preferred that, in a case in which four piezoelectric elements 9 are provided, the split vibration-transmitting members 10c and 10d each be provided with two piezoelectric elements 9 that are perpendicularly disposed.

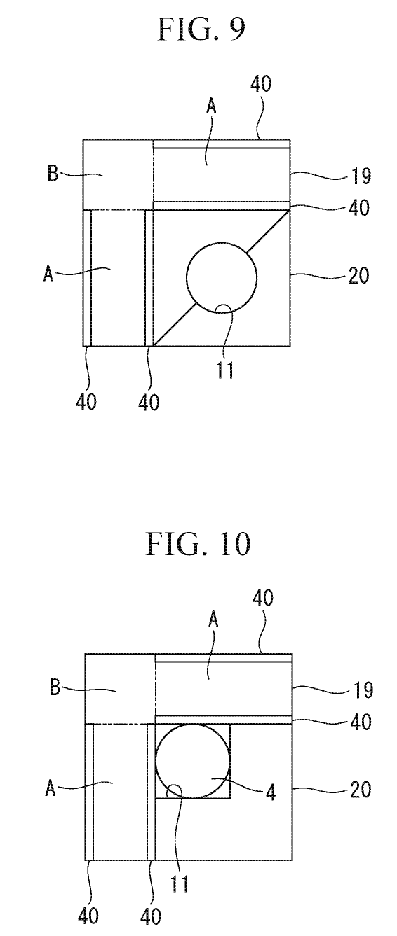

Instead of this, as shown in FIG. 9, in a case in which two piezoelectric elements 9 are provided, a piezoelectric element 19 having an L-shaped transverse cross-section, in which two active portions A that are formed by providing the electrodes 40 thereon are coupled by means of an inactive portion B that has no electrodes 40, may be fixed to one of two parts into which a ferrule 20 that is a square cylinder is diagonally split.

Furthermore, as shown in FIG. 10, it is also possible to form a cylindrical unit having a square transverse cross-section by combining the piezoelectric element 19, which has an L-shaped transverse cross-section, with a ferrule 20 that has an L-shaped transverse cross-section and to accommodate the optical fiber 4 in a through-hole 11 that is located at the center and that has a square cross-section.

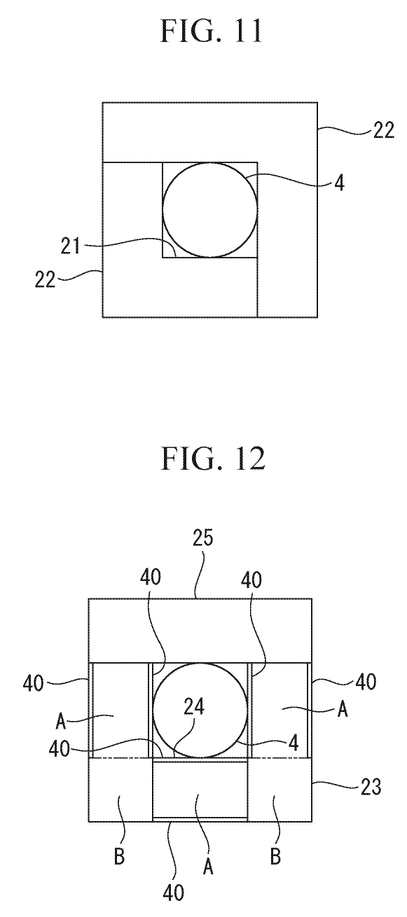

Furthermore, in a case in which the piezoelectric elements 19 are directly bonded to the surface of the optical fiber 4 without using the ferrule 10, 20, as shown in FIG. 11, it is also possible to form a cylindrical unit having a square transverse cross-section by combining two piezoelectric elements 22 each having an L-shaped transverse cross-section and to accommodate the optical fiber 4 in a through-hole 21 that is located at the center and that has a square cross-section.

Furthermore, as shown in FIG. 12, it is also possible to adopt a structure in which the electrodes 40 are formed at three places on a piezoelectric element 23 that has a groove 24 and that has a U-shaped transverse cross-section, thereby causing the piezoelectric element 23 to have a structure in which three active portions A are coupled by means of two inactive portions B, the optical fiber 4 is accommodated in the groove 24 of the piezoelectric element 23, and an open section of the groove 24 is blocked by a square-shaped (for example, rectangular) piezoelectric element 25.

Next, an optical-scanning-type illumination device 26 according to a second embodiment of the present invention will be described below with reference to the drawings.

In the description of this embodiment, identical reference signs are assigned to portions that have structures common to those of the optical-scanning-type illumination device 2 according to the above-described first embodiment, and a description thereof will be omitted.

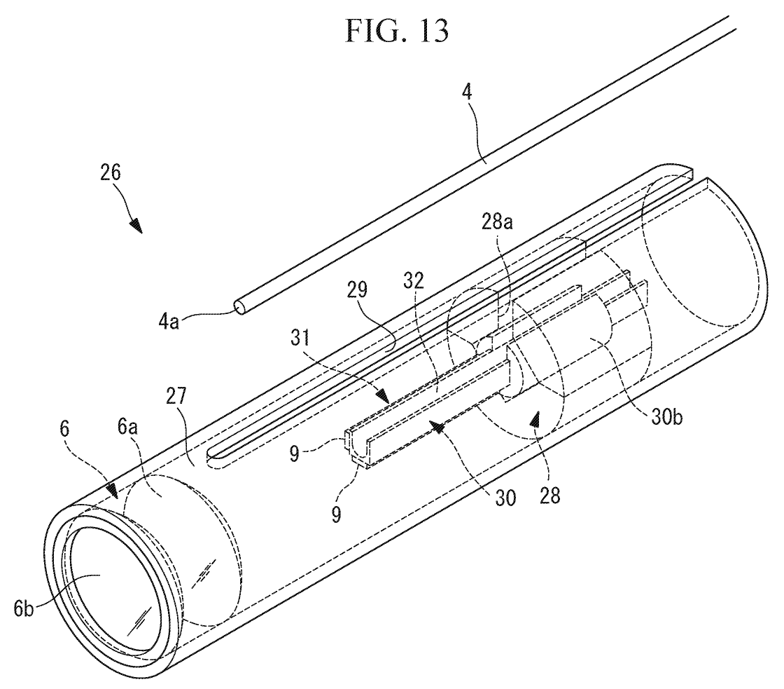

As shown in FIG. 13, the optical-scanning-type illumination device 26 of this embodiment does not adopt the outer tube 7, which has a split structure, and adopts an integrated cylindrical outer tube 27. In the outer tube 27, the optical system 6 is fixed at a distal end section thereof, and a support member 28 is fixed at a position spaced apart from the optical system 6 toward the base end.

Furthermore, the outer tube 27 is provided with, at one position in the circumferential direction, a slit (opening section) 29 that linearly extends along the longitudinal-axis direction from the base end to a position closer to the base end than the optical system 6 is. Furthermore, the support member 28, which is fixed inside the outer tube 27, is also provided with a slit 28a that has the same width as the slit 29 of the outer tube 27, at the same phase position as the slit 29 of the outer tube 27.

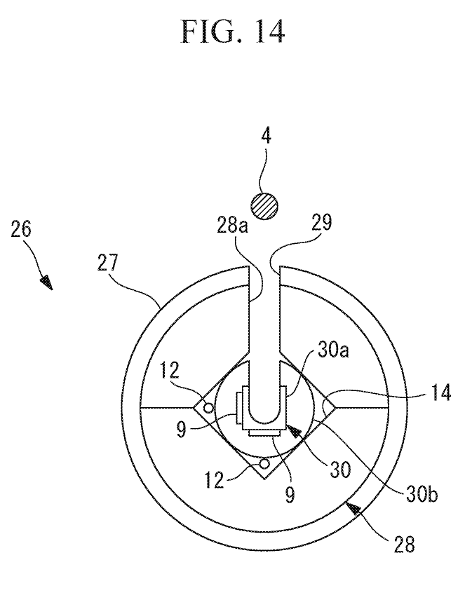

Furthermore, a ferrule 30 that has a square cylinder section 30a and a circular cylinder section 30b, the piezoelectric elements 9 that are bonded to the ferrule 30, and the wires 12 that are wired to the piezoelectric elements 9 are fixed to the support member 28, which is fixed inside the outer tube 27, by an adhesive agent. As shown in FIGS. 13 and 14, the ferrule 30 is provided with a straight groove 32 over the entire length of the circular cylinder section 30b and the square cylinder section 30a, at a position corresponding to the slit 29 of the outer tube 27. The groove has a width size slightly larger than the size of the optical fiber 4.

In this embodiment, the piezoelectric elements 9 are respectively bonded to two adjacent surfaces of the square cylinder section 30a of the ferrule 30 other than a surface thereof where the groove 32 is provided.

In order to insert an assembly body 31 of the ferrule 30 and the piezoelectric elements 9 into the support member 28, the assembly body 31 is inserted thereinto from a base-end opening of the outer tube 27, starting from the distal end of the ferrule 30. In a state in which the optical fiber 4 is not mounted, it is not necessary to care about damage to the distal end 4a of the optical fiber 4.

In this state, as shown in FIGS. 13 and 14, the optical fiber 4 disposed parallel to the longitudinal axis of the outer tube 27 is made to approach the outer tube 27 from the outside of the outer tube 27 in a radial direction and is inserted into the outer tube 27 via the slit 29. Thereafter, the optical fiber 4 is made to pass through the slit 28a, which is formed in the support member 28, in the radial direction, and is accommodated in the groove 32, which is formed in the ferrule 30, and the ferrule 30 and the optical fiber 4 are bonded by an adhesive agent, thereby forming the optical-scanning-type illumination device 26.

According to this embodiment, as in the first embodiment, when the optical fiber 4 is mounted, because movement of the optical fiber 4 with respect to the outer tube 27 in the longitudinal-axis direction need not be involved, there is an advantage in that damage of the distal end 4a of the optical fiber 4 can be prevented at the time of assembly.

Furthermore, because the outer tube 27 is not formed to have a split structure, there is an advantage in that the number of components can be reduced, thus making it possible to manufacture the outer tube 27 at lower cost.

Note that, the optical fiber 4 is accommodated in the groove 32 of the ferrule 30 and is bonded thereto by the adhesive agent, and the slits 29 and 28a provided in the outer tube 27 and the support member 28 are also filled with the adhesive agent, thereby making it possible to more reliably fix the ferrule 30 to the support member 28.

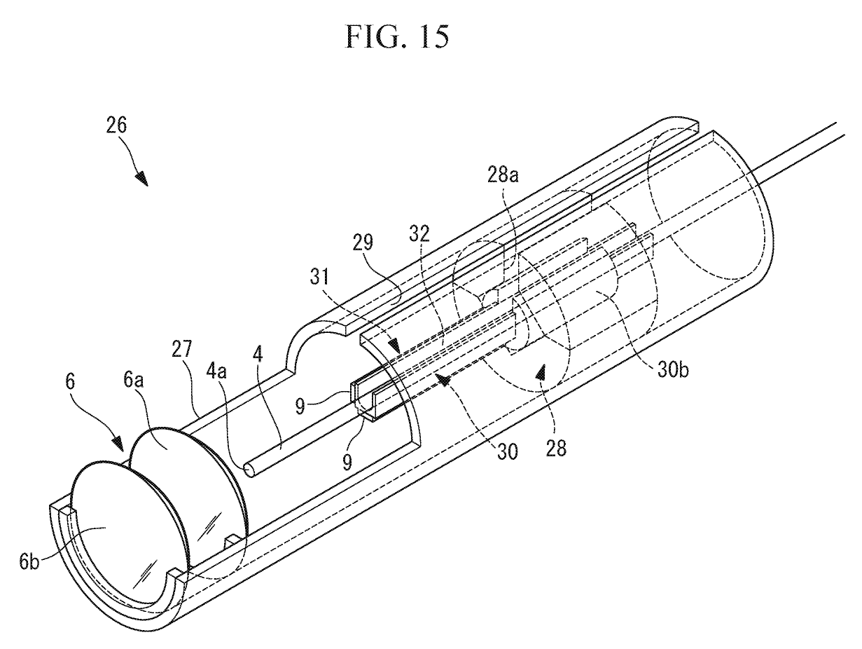

Furthermore, in the above-described embodiment, although the slit 29, which linearly extends along the longitudinal-axis direction, is provided in the outer tube 27 at one position in the circumferential direction from the base end to a position closer to the base end than the optical system 6 is, instead of this, it is also possible to use an opening section that linearly penetrates the outer tube 27 from the base end to the distal end of the outer tube 27 along the longitudinal-axis direction. Furthermore, the opening section may have an arbitrary shape and width. For example, as shown in FIG. 15, the opening section may be provided with, at the distal end of the slit 29, a large opening section that is obtained by removing a semi-cylindrical section of the outer tube 27 from the distal end of the outer tube 27 to a predetermined position close to the base end thereof.

Furthermore, although optical fibers that are circumferentially arranged directly on the outer circumferential surface of the outer tube 27 are used as the light-receiving optical fibers 3, which guide return light, instead of this, optical fibers may also be provided on a cylinder-shaped covering member that covers the outer circumferential surface of the outer tube 27.

Furthermore, as the optical-scanning-type observation system 100, it is preferred that the slit 29 and the large opening section be covered with the above-described covering member or another light shielding member, from the outside. By doing so, it is possible to suppress leakage of illumination light from the slit 29 and to appropriately separate illumination light from return light.

Furthermore, in the above-described embodiment, although a slit that has a width larger than the optical fiber 4 and smaller than the ferrule 30 is used as the slit 29, which is provided in the outer tube 27, it is also possible to use a slit that has a width larger than the ferrule 30 and to accommodate the ferrule 30 from the slit 29. In this case, because the ferrule can be removably inserted into the outer tube 27, it is also possible to use the ferrule 10, 20, which does not have the groove 32, instead of the ferrule 30, which has the groove 32.

Furthermore, the scanner unit 5 that has been inserted into the outer tube 27 may also be provided so as to be slightly movable in the longitudinal-axis direction of the outer tube 27, thus allowing focus adjustment.

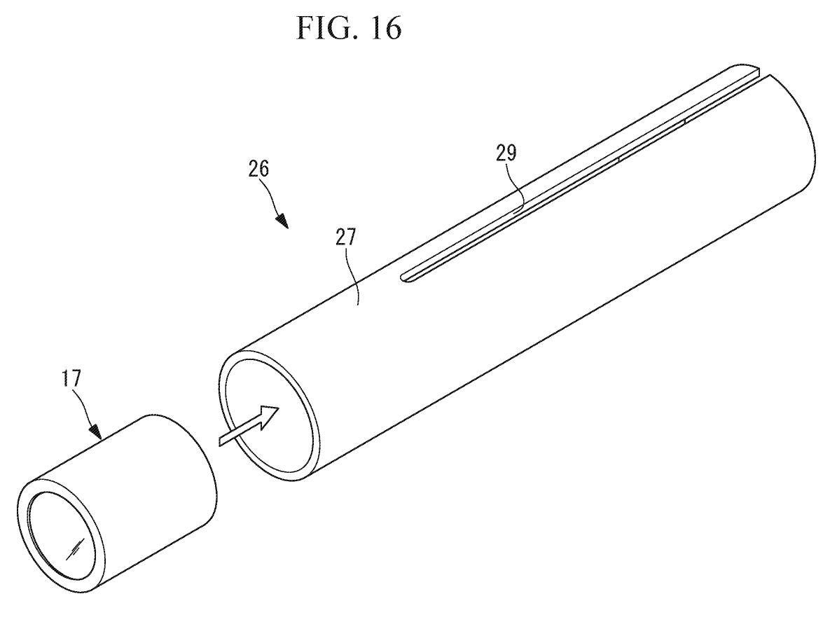

Furthermore, in this embodiment, instead of the case in which the individual lenses 6a and 6b are mounted, as shown in FIG. 16, a lens unit 17 may be accommodated from the distal end of the outer tube 27 and may be engaged with a stopper that is made to project at a predetermined position of the inner surface of the outer tube 27, thereby being positioned in the longitudinal-axis direction of the outer tube 27.

Furthermore, in this embodiment, although only the optical fiber 4 is made to approach the outer tube 27 in the radial direction and is accommodated in the outer tube 27 and in the groove 32 of the ferrule 30 from the slits 28a and 29, instead of this, it is also possible to increase the width of the slits 29 and 28a of the outer tube 27 and the support member 28 and to accommodate the whole of the scanner unit 5, which is provided with the optical fiber 4, the ferrule 30, and the piezoelectric elements 9, in the outer tube 27 from the outside in the radial direction via the slits 28a and 29. Furthermore, it is also possible to individually accommodate the optical fiber 4, the ferrule 30, and the piezoelectric elements 9 in the outer tube 27 from the outside in the radial direction via the slits 28a and 29 and to assemble them into the scanner unit 5 inside the outer tube 27.

Furthermore, after only the optical fiber 4 of the scanner unit 5, which is obtained by assembling the optical fiber 4, the ferrule 30, and the piezoelectric elements 9, is made to pass through the slits 29 and 28a of the outer tube 27 and the support member 28 in the radial direction, the circular cylinder section 30b of the ferrule 30 may be fitted into a central hole (V-grooves) 14 of the support member 28 in the axial direction. With this structure, the distal end 4a of the optical fiber 4 need not be inserted from the base end of the outer tube 27, thus making it possible to achieve prevention of damage at the time of assembly.

Furthermore, although optical fibers that are circumferentially arranged directly on the outer circumferential surface of the outer tube 27 are used as the light-receiving optical fibers 3, which guide return light, instead of this, optical fibers may also be provided on a cylinder-shaped covering member that covers the outer circumferential surface of the outer tube 27.

Furthermore, as the optical-scanning-type observation system 100, it is preferred that the slit 29 be covered with the above-described covering member or another light shielding member, from the outside. By doing so, it is possible to suppress leakage of illumination light from the slit 29 and to appropriately separate illumination light from return light.

As a result, the above-described embodiments also lead to the following aspects.

One aspect of the present invention provides an optical-scanning-type illumination device including: an optical fiber that guides illumination light and that emits the illumination light from a distal end thereof; a vibration unit that vibrates the distal end of the optical fiber in a direction perpendicular to a longitudinal axis of the optical fiber; an optical system that focuses the illumination light emitted from the distal end of the optical fiber; an outer tube that accommodates the optical fiber, the vibration unit, and the optical system; and a support member that supports the vibration unit in the outer tube, wherein the outer tube and the support member have a structure in which at least the optical fiber can be accommodated therein from a direction perpendicular to the longitudinal axis of the outer tube.

According to this aspect, the optical fiber, the vibration unit, and the optical system are accommodated in the outer tube, the vibration unit is supported in the outer tube by the support member, the vibration unit is actuated to vibrate the distal end of the optical fiber in a direction perpendicular to the longitudinal axis, illumination light from the light source is emitted from the distal end of the optical fiber via the inside of the optical fiber, and the emitted illumination light is focused by the optical system, is radiated onto an object, and is scanned on the object. Accordingly, the illumination light can be radiated over in a wide area of the object.

In this case, when at least the optical fiber is accommodated in the outer tube, which accommodates the optical fiber, the vibration unit, and the optical system, the optical fiber can be accommodated in the outer tube from a direction perpendicular to the longitudinal axis of the outer tube, and the distal end of the optical fiber need not be inserted from the base end of the outer tube, thus making it possible to perform assembly without damaging the distal end of the optical fiber.

In the above-described aspect, the outer tube and the support member may each be provided with a plurality of split members that can be split along a parting line extending along the longitudinal axis of the outer tube.

By doing so, the outer tube and the support member are each split into the plurality of split members along the parting line, and, after an assembly body of the optical fiber and the vibration unit is made to approach one of the split members from a direction perpendicular to the longitudinal axis of the outer tube and is assembled therein, the other one of the split members is combined with the one of the split members, thus forming the outer tube. With this structure, the distal end of the optical fiber need not be inserted from the base end of the outer tube, thus making it possible to perform assembly without damaging the distal end of the optical fiber.

Furthermore, in the above-described aspect, the split members may be provided with engagement sections that are engaged with each other in the longitudinal-axis direction when the split members are combined.

By doing so, the assembled split members are engaged with each other in the longitudinal-axis direction by means of the engagement sections, thereby being assembled in a mutually positioned state.

Furthermore, in the above-described aspect, the vibration unit may be provided with: at least one piezoelectric element that expands and contracts in the longitudinal-axis direction of the optical fiber through application of a voltage; and a cylindrical vibration transmitting member that is disposed between the piezoelectric element and the optical fiber and that transmits an expansion and contraction motion of the piezoelectric element to the optical fiber; and the vibration transmitting member may be provided with a plurality of split vibration-transmitting members that can be split along the parting line.

By doing so, the outer tube and the support member are each split into the plurality of split members along the parting line, the cylindrical vibration transmitting member is split into the plurality of split vibration-transmitting members along the parting line, and each of the split vibration-transmitting members is supported by corresponding one of the split members of the support member. Then, the optical fiber is made to approach the split vibration-transmitting member supported by the one of the split members, in a direction perpendicular to the longitudinal axis of the outer tube and is assembled therein.

Thereafter, the one of the split members and the other one of the split members are assembled to form the outer tube, thus forming the cylindrical vibration transmitting member surrounding the optical fiber, and forming a state in which the optical fiber and the vibration unit are supported by the support member in the outer tube. Accordingly, the distal end of the optical fiber need not be inserted from the base end of the outer tube, and the distal end of the optical fiber need not be inserted from the base end of the cylindrical vibration transmitting member, thus making it possible to perform assembly without damaging the distal end of the optical fiber.

Furthermore, in the above-described aspect, the support member may have a V-groove that extends along the longitudinal axis of the outer tube and that supports the vibration transmitting member; and an outer surface of a section of the vibration transmitting member that is supported by the V-groove may be a cylindrical surface extending along the longitudinal axis of the optical fiber.

By doing so, when the vibration transmitting member is supported by the support member in the outer tube, the cylindrical surface of the vibration transmitting member is brought into contact with the V-groove, which is provided in the support member, thereby making it possible to position the vibration transmitting member and the support member in the radial direction with ease and accuracy.

Furthermore, in the above-described aspect, the outer tube and the support member may be provided with, at a circumferential section thereof, a straight opening section that extends along the longitudinal-axis direction of the outer tube and that has a width size through which at least the optical fiber can pass.

By doing so, at least the optical fiber can be accommodated in the outer tube from a direction perpendicular to the longitudinal axis of the outer tube via the opening section, which is provided in the outer tube and the support member, and the distal end of the optical fiber need not be inserted from the base end of the outer tube, thus making it possible to perform assembly without damaging the distal end of the optical fiber.

Furthermore, in the above-described aspect, the vibration unit may be provided with: at least one piezoelectric element that expands and contracts in the longitudinal-axis direction of the optical fiber through application of a voltage; and a vibration transmitting member that is disposed between the piezoelectric element and the optical fiber and that transmits an expansion and contraction motion of the piezoelectric element to the optical fiber; and the outer tube, the support member, and the vibration transmitting member may be provided with, at a circumferential section thereof, a straight opening section that extends along the longitudinal-axis direction of the outer tube and that has a width size through which at least the optical fiber can pass.

By doing so, after the optical fiber is accommodated in the outer tube from a direction perpendicular to the longitudinal axis of the outer tube via the opening section, which is provided in the outer tube, assembly can be performed so as to accommodate the optical fiber in the vibration transmitting member from the direction perpendicular to the longitudinal axis of the outer tube via the opening section, which is provided in the vibration transmitting member. Accordingly, the distal end of the optical fiber need not be inserted from the base ends of the outer tube and the vibration transmitting member, thus making it possible to perform assembly without damaging the distal end of the optical fiber.

Furthermore, in the above-described aspect, the opening section of the outer tube may extend from a base end of the outer tube to a position closer to the base end than the optical system is.

By doing so, a section of the outer tube in which the optical system is accommodated can be formed in a cylinder shape having no opening section.

Furthermore, another aspect of the present invention provides an optical-scanning-type observation device including: one of the above-described optical-scanning-type illumination devices; and a plurality of light-receiving optical fibers that are disposed so as to surround the outer circumference of the outer tube of the optical-scanning-type illumination device and that receive light from an object.

According to the present invention, an advantageous effect is afforded in that assembly can be performed without damaging a distal end of an optical fiber.

### REFERENCE SIGNS LIST

1 optical-scanning-type observation device
2, 26 optical-scanning-type illumination device
3 light-receiving optical fiber
4 optical fiber
4a distal end
5 scanner unit (vibration unit)
6 optical system
7, 27 outer tube
8, 28 support member
9, 19, 22, 23, 25 piezoelectric element
10, 30 ferrule (vibration transmitting member)
10c, 10d split vibration-transmitting member
13 semi-circular tube member (split member)
14 V-groove
15 split support member (split member)
17 lens unit (optical system)
18 engagement section
29 slit (opening section)
X object

1. A scanning-type device comprising:
an optical fiber;
a vibration unit that vibrates a distal end of the optical fiber in a direction perpendicular to a longitudinal axis of the optical fiber;
an outer tube that accommodates the optical fiber and the vibration unit; and
a support member that supports the vibration unit in the outer tube,
wherein the vibration unit comprising: a piezoelectric element that expands and contracts in the longitudinal-axis direction of the optical fiber; and a cylindrical vibration transmitting member that is disposed between the piezoelectric element and the optical fiber and that transmits expansion and contraction vibrations of the piezoelectric element to the optical fiber;
the support member has a V-groove that extends along a longitudinal axis of the outer tube to support the vibration transmitting member; and
an outer surface of a section of the vibration transmitting member that is supported by the V-groove is a cylindrical surface extending along the longitudinal axis of the optical fiber.

2. The scanning-type device according to claim 1, wherein the outer tube and the support member are each configured to be split into a plurality of split members along a parting line extending along the longitudinal axis of the outer tube.

3. The scanning-type device according to claim 2, wherein the plurality of split members are provided with engagement sections that are engaged with each other in the longitudinal-axis direction when the plurality of split members are combined.

4. A scanner unit comprising:
an optical fiber;
a piezoelectric element in which an active portion formed by being sandwiched between electrodes and an inactive portion having no electrodes are coupled and that expands and contracts in a longitudinal-axis direction of the optical fiber through application of a voltage; and
a vibration transmitting member that transmits expansion and contraction vibrations of the piezoelectric element to the optical fiber,
wherein the optical fiber is accommodated in a center of the vibration transmitting member or in a center of a tube having a square transverse cross-section and obtained by combining the vibration transmitting member and the piezoelectric element; and
the vibration transmitting member is configured to be split, or the vibration transmitting member and the piezoelectric element are configured to be split.

5. A scanner unit comprising:
an optical fiber; and
two or more piezoelectric elements in each of which an active portion formed by being sandwiched between electrodes and an inactive portion having no electrodes are coupled and that expand and contract in a longitudinal-axis direction of the optical fiber through application of a voltage,
wherein the optical fiber is accommodated in a center of a tube having a square transverse cross-section and obtained by combining the two or more piezoelectric elements; and
the two or more piezoelectric elements are configured to be split.
